(19) United States
(12) Patent Application Publication
(10) Pub. No.: US 2010/0332318 A1
(43) Pub. Date: Dec. 30, 2010

(54) METHOD FOR EXPOSING AUTOMATIC SEARCH ADVERTISEMENT AND SYSTEM THEREOF

(75) Inventors: Kyoung Sun Kim, Seoul (KR); Kyungsun Ko, Seoul (KR)

Correspondence Address: H.C. PARK & ASSOCIATES, PLC, 8500 LEESBURG PIKE, SUITE 7500, VIENNA, VA, 22182, US

(73) Assignee: NHN BUSINESS PLATFORM CORPORATION, Seongsam-si (KR)

(21) Appl. No.: 12/666,503

(22) PCT Filed: May 23, 2008
(86) PCT No.: PCT/KR08/02891

§ 371 Date: Dec. 23, 2009

(30) Foreign Application Priority Data
Jun. 28, 2007 (KR) 10-2007-0064327

(51) Int. Cl. G06Q 30/00

(52) U.S. Cl. 705/14.49

(57) ABSTRACT

An automatic search advertisement presentation method, including: analyzing a keyword included in a title of an advertiser website, description of the advertiser website, content of the advertiser website, or condition entered by an advertiser; generating an impression keyword based on a result of the analysis; receiving a query from a user; comparing the query and the impression keyword; and presenting an advertisement corresponding to the impression keyword based on a result of the comparing.

### CROSS-REFERENCE TO RELATED APPLICATIONS

This application is the National Stage of International Application No. PCT/KR2008/002891, filed May 23, 2008, and claims priority from and the benefit of Korean Patent Application No. 10-2007-0064327, filed on Jun. 28, 2007, which are both hereby incorporated by reference for all purposes as if fully set forth herein.

### BACKGROUND OF THE INVENTION

1. Field of the Invention

The present invention relates to an automatic search advertisement presentation method and system, and more particularly, to an automatic search advertisement presentation method and system which presents an advertisement based on a result of comparing a user input query and impression keyword generated based on a result of analyzing a title or description of an advertiser website.

2. Discussion of the Background

In general, when an advertiser purchases an advertisement keyword in advance and the advertisement is included in a query entered by a user, a search advertisement presentation method presents an advertisement of the advertiser that purchases the advertisement keyword. For example, when an advertiser purchases an advertisement keyword of ‘camera’ and ‘camera’ is included in a query entered by a user, a search advertisement presentation method presents an advertisement of the advertiser.

As described above, in a search advertisement presentation method in a conventional art, an advertisement corresponding to an advertisement keyword may be presented only when an advertiser purchases the advertisement keyword. Accordingly, an advertisement of an advertiser that does not purchase an advertisement keyword may not be presented.

Also, in a search advertisement presentation method in a conventional art, an advertisement may be presented only when an advertisement keyword purchased by an advertiser is inputted as a query. Accordingly, when the advertisement keyword is not a popular keyword, an opportunity to present the advertisement may be limited.

### SUMMARY OF THE INVENTION

The present invention provides an automatic search advertisement presentation method and system which analyzes a title or description of a website of the advertiser and presents an advertisement.

The present invention also provides an automatic search advertisement presentation method and system which presents an advertisement when a keyword is inputted as a query based on a result of analyzing a title, content, description, or condition of an advertisement website.

The present invention also provides an automatic search advertisement presentation method and system which analyzes a keyword included in a title, content, description, or condition of an advertisement website, generates a variety of expanded keywords such as an autocomplete keyword, related keyword, recommended keyword, and the like, and presents an advertisement.

The present invention also provides an automatic search advertisement presentation method and system which addresses a request of an advertiser by using request information of the advertiser to present an advertisement.

The present invention also provides an automatic search advertisement presentation method and system which addresses a request of a user by using input information of the user to present an advertisement.

According to an aspect of the present invention, there is provided an automatic search advertisement presentation method, including: analyzing a keyword included in a title of an advertiser website, description of the advertiser website, content of the advertiser website, or condition entered by an advertiser; generating an impression keyword based on a result of the analysis; receiving a query from a user; comparing the query and the impression keyword; and presenting an advertisement corresponding to the impression keyword based on a result of the comparing.

According to another aspect of the present invention, there is provided an automatic search advertisement presentation system, including: an advertisement analysis unit analyzing a keyword included in a title of an advertiser website, description of the advertiser website, content of the advertiser website, or condition entered by an advertiser; an impression keyword generation unit generating an impression keyword based on a result of the analysis; an input unit receiving a query from a user; a comparison unit comparing the query and the impression keyword; and an advertisement presentation unit presenting an advertisement corresponding to the impression keyword based on a result of the comparing.

According to the present invention, an impression keyword is generated by analyzing a title, description, content, or condition of an advertiser website, and when the impression keyword is included in a query of a user, an advertisement corresponding to the impression keyword may be presented.

### BRIEF DESCRIPTION OF THE DRAWINGS

FIG. 1 is a diagram illustrating a relationship of a user terminal, advertiser terminal, and automatic search advertisement presentation system according to an embodiment of the present invention.

FIG. 2 is a diagram illustrating a configuration of an automatic search advertisement presentation system according to an embodiment of the present invention.

FIG. 3 is a diagram illustrating an example of a title, description, and Uniform Resources Locator (URL) of an advertiser website.

FIG. 4 is a diagram illustrating an example of a result of analyzing a title and description of an advertiser website based on a minimum unit.

FIG. 5 is a diagram illustrating an example of an impression keyword generated using a keyword analyzed based on a minimum unit.

FIG. 6 is a diagram illustrating an example of an autocomplete query using a keyword analyzed based on a minimum unit.

FIG. 7 is a diagram illustrating an example of a related keyword associated with a keyword analyzed based on a minimum unit.

FIG. 8 is a diagram illustrating an example of an impression keyword generated using an autocomplete query, related keyword, or keyword analyzed based on a minimum unit.

FIG. 9 is a diagram illustrating an example of presenting an advertisement corresponding to an input query.

FIG. 10 is a flowchart illustrating an automatic search advertisement presentation method according to an embodiment of the present invention.

### DETAILED DESCRIPTION OF THE ILLUSTRATED EMBODIMENTS

Hereinafter, embodiments of the present invention are described in detail by referring to the figures.

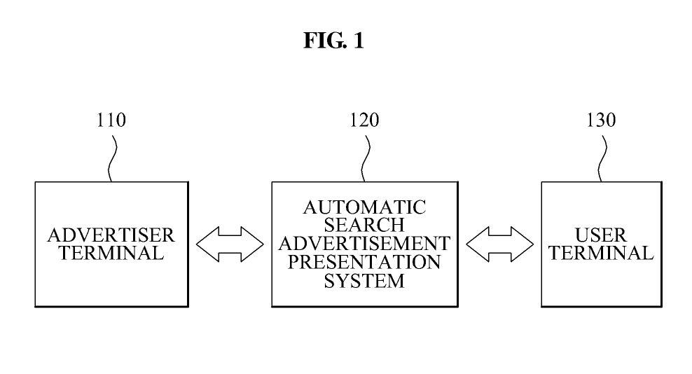

FIG. 1 is a diagram illustrating a relationship of a user terminal 130, advertiser terminal 110, and automatic search advertisement presentation system 120 according to an embodiment of the present invention.

Referring to FIG. 1, the advertiser terminal 110 receives an advertisement to be advertised, a title of an advertiser website, a description of the advertiser website, a Uniform Resources Locator (URL) of the advertiser website, or an advertisement condition, from an advertiser. The advertiser terminal 110 provides the title, description, URL of the advertiser website, or advertisement condition, entered by the advertiser, to the automatic search advertisement presentation system 120.

The automatic search advertisement presentation system 120 analyzes the title, description, URL of the advertiser website, or advertisement condition, provided from the advertiser terminal 110. That is, the automatic search advertisement presentation system 120 analyzes a keyword, included in the title, description, URL of the advertiser website, or advertisement condition, based on a minimum unit. The automatic search advertisement presentation system 120 individually generates the keyword analyzed based on the predetermined unit as an impression keyword, or combines the keywords analyzed based on the minimum unit to generate the impression keyword. Also, the automatic search advertisement presentation system 120 may generate an autocomplete query or related keyword using the keyword analyzed based on the minimum unit. Also, the automatic search advertisement presentation system 120 may combine the keyword analyzed based on the minimum unit, and the autocomplete query or the related keyword to generate the impression keyword.

The user terminal 130 receives a query from a user. That is, the user terminal 130 interoperates with the automatic search advertisement presentation system 120. The user terminal 130 may receive a query to use a search service from the user. The user terminal 130 provides the query entered by the user to the automatic search advertisement presentation system 120.

The automatic search advertisement presentation system 120 compares the query and the impression keyword. That is, the automatic search advertisement presentation system 120 compares the impression keyword and a keyword included in the query. Also, the automatic search advertisement presentation system 120 presents an advertisement corresponding to the impression keyword based on a result of the comparing. That is, when the impression keyword is included in the query based on the result of the comparing, the automatic search advertisement presentation system 120 may present the advertisement corresponding to the impression keyword. For example, the automatic search advertisement presentation system 120 may preferentially present an advertisement of an advertiser that purchases the impression keyword as an advertisement keyword based on the result of the comparing, and present an advertisement corresponding to an impression keyword of an advertiser that does not purchase the advertisement keyword. A variety of accounting methods such as a Cost per click (CPC) method or flat sum payment method may be applied to the automatic search advertisement presentation system 120.

The user terminal 130 may be provided with the advertisement presented together with a search result with respect to the query by the automatic search advertisement presentation system 120.

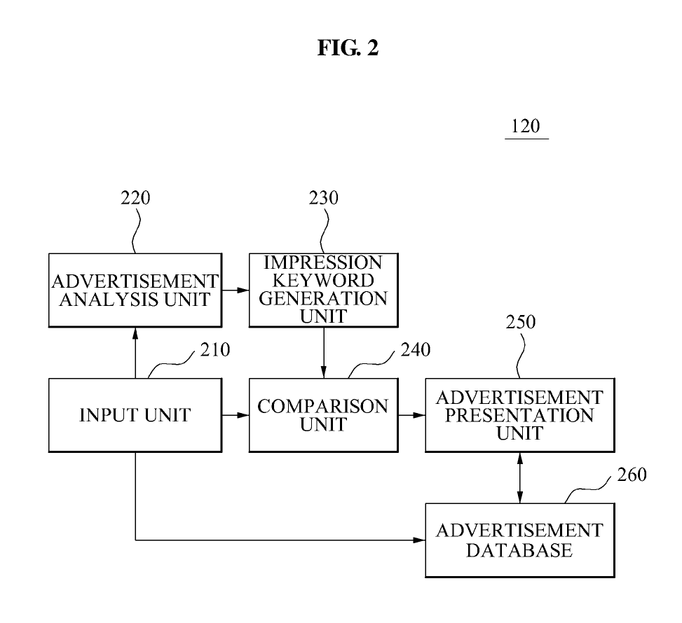

FIG. 2 is a diagram illustrating a configuration of an automatic search advertisement presentation system 120 according to an embodiment of the present invention.

Referring to FIG. 2, the automatic search advertisement presentation system 120 includes an input unit 210, advertisement analysis unit 220, impression keyword generation unit 230, comparison unit 240, advertisement presentation unit 250, and advertisement database 260.

The input unit 210 receives a title, description of an advertiser website, advertisement content, or advertisement condition from an advertiser. Specifically, the input unit 210 may receive the title, description, and URL of the advertiser website, advertisement content, or advertisement condition from the advertiser.

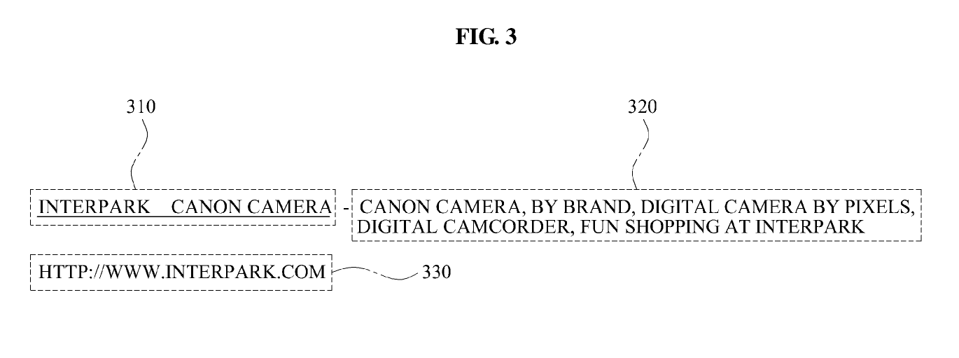

FIG. 3 is a diagram illustrating an example of a title 310, description 320, and URL 330 of an advertiser website.

Referring to FIG. 3, the title 310 of the advertiser website may be a title of an advertiser website desired to be advertised by an advertiser, for example, ‘Interpark Canon camera’. The description 320 of the advertiser web site may be words to describe a website desired to be advertised by the advertiser to a user, for example, ‘Canon camera, by brand, digital camera by pixels, digital camcorder, fun shopping at Interpark’. The URL 330 of the advertiser website may be URL information of the advertiser website, for example, ‘http://www.interpark.com’.

Also, the input unit 210 receives a query from the user. That is, the input unit 210 may receive the query corresponding to content desired to be retrieved by the user.

The advertisement analysis unit 220 analyzes the title or description of the advertiser website. That is, the advertisement analysis unit 220 may analyze a keyword included in the title, description, content of the advertiser website, or condition entered by the advertiser. The advertisement analysis unit 220 obtains the content of the advertiser website through crawling using the URL information of the advertiser website, and thereby may analyze the content of the advertiser website.

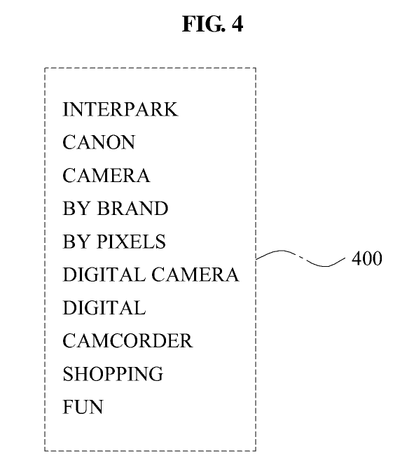

FIG. 4 is a diagram illustrating an example of a result of analyzing a title and description of an advertiser website based on a minimum unit.

Referring to FIG. 4, a minimum unit list 400 includes keywords separated by the minimum unit. The keywords are included in a result of the analyzing content of the advertiser website through crawling using the title 310, description 320, and URL 330 of the advertiser website illustrated in FIG. 3. The minimum unit may be a smallest unit where the keyword independently has a meaning. The advertisement analysis unit 220 may analyze the keywords, ‘Interpark Canon camera’, included in the title 310 of the advertiser website illustrated in FIG. 3, and thereby may separate the keywords into the minimum unit such as ‘Interpark, Canon, camera’ included in the minimum unit list 400. Also, the advertisement analysis unit 220 may analyze the keywords, ‘Canon camera, by brand, digital camera by pixels, digital camcorder, fun shopping at Interpark’, included in the description 320 of the advertiser website illustrated in FIG. 3, and thereby may separate the keywords into the minimum unit such as ‘Canon, camera, by brand, digital camera, by pixels, digital, camcorder, fun, shopping’ included in the minimum unit list 400. As described above, the advertisement analysis unit 220 may analyze the keywords included in the title 310 of the advertiser website or description 320 of the advertiser website, based on a predetermined unit.

Also, the advertisement analysis unit 220 may analyze an autocomplete query or related keyword as an expanded keyword. The autocomplete query or related keyword is generated using the keyword analyzed based on the predetermined unit.

The impression keyword generation unit 230 generates an impression keyword based on a result of the analysis. For example, the impression keyword generation unit 230 may individually use the keywords analyzed based on the predetermined unit as the impression keyword, or combine the keywords analyzed based on the predetermined unit to generate the impression keyword.

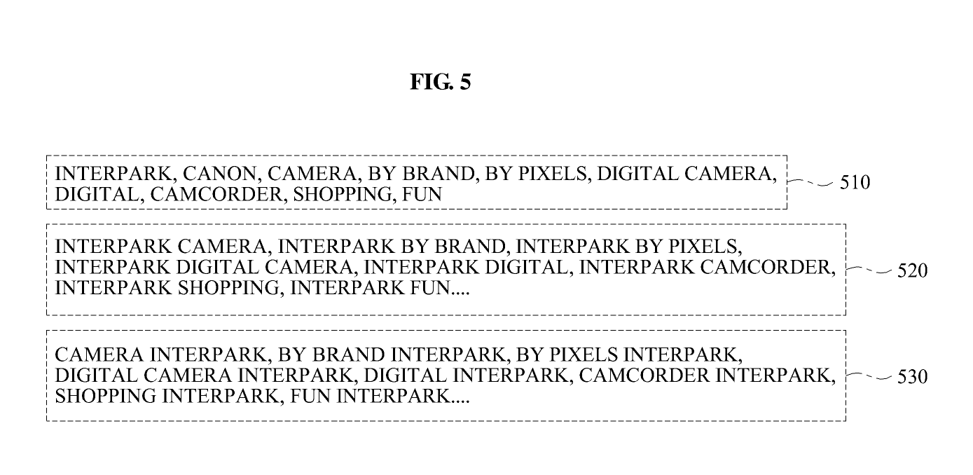

FIG. 5 is a diagram illustrating an example of an impression keyword generated using a keyword analyzed based on a minimum unit.

Referring to FIG. 5, the impression keyword generation unit 230 may individually use the keyword, analyzed based on the predetermined unit, that is, the minimum unit, based on a result of the analyzing, and thereby may generate a first impression keyword 510. For example, keywords such as ‘Interpark, Canon, camera, by brand, by pixels, digital camera, digital, camcorder, shopping, fun’ included in the minimum unit list 400 illustrated in FIG. 4 may be individually used as the first impression keyword 510.

Also, the impression keyword generation unit 230 may combine the keywords analyzed based on the predetermined unit based on the result of the analyzing, and thereby may generate a second impression keyword 520 or third impression keyword 530. For example, the second impression keyword 520, ‘Interpark camera, Interpark by brand, Interpark by pixels, Interpark digital camera, Interpark digital, Interpark camcorder, Interpark shopping, Interpark fun’, may be generated by combining the keyword ‘Interpark’ and the other keywords ‘Canon, camera, by brand, by pixels, digital camera, digital, camcorder, shopping, fun’ excluding the keyword ‘Interpark’. In this instance, the keyword ‘Interpark’ is located in front of the keywords ‘Canon, camera, by brand, by pixels, digital camera, digital, camcorder, shopping, fun’. All the keywords ‘Interpark, Canon, camera, by brand, by pixels, digital camera, digital, camcorder, shopping, fun’ are included in the minimum unit list 400 illustrated in FIG. 4. Also, for example, the third impression keyword 530 such as ‘camera Interpark, by brand Interpark, by pixels Interpark, digital camera Interpark, digital Interpark, camcorder Interpark, shopping Interpark, fun Interpark’ may be generated by combining the other keywords ‘Canon, camera, by brand, by pixels, digital camera, digital, camcorder, shopping, fun’ excluding the keyword ‘Interpark’, and the keyword ‘Interpark’. In this instance, the keywords ‘Canon, camera, by brand, by pixels, digital camera, digital, camcorder, shopping, fun’ are located in front of the keyword ‘Interpark’.

For example, the impression keyword generation unit 230 may individually use the keyword, analyzed based on the predetermined unit, or expanded keyword. Alternatively, the impression keyword generation unit 230 may combine the keyword analyzed based on the predetermined unit and expanded keyword, and thereby may generate the impression keyword.

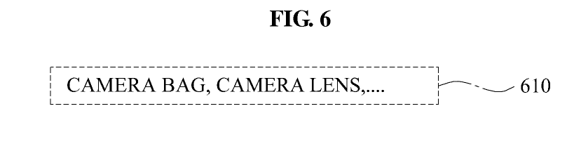

FIG. 6 is a diagram illustrating an example of an autocomplete query using a keyword analyzed based on a minimum unit.

Referring to FIG. 6, the impression keyword generation unit 230 may extract an autocomplete query 610 by analyzing the keywords included in the minimum unit list 400 illustrated in FIG. 4. Also, the impression keyword generation unit 230 may generate an expanded impression keyword using the autocomplete query 610. For example, when a keyword ‘camera’ included in the minimum unit list 400 is entered by a user, and a query such as ‘camera bag’ or ‘camera lens’ is commonly entered, such a query of the user may be analyzed in advance. Accordingly, when only ‘camera’ is entered by the user as the keyword, the autocomplete query 610 such as ‘camera bag, camera lens’ may be automatically completed.

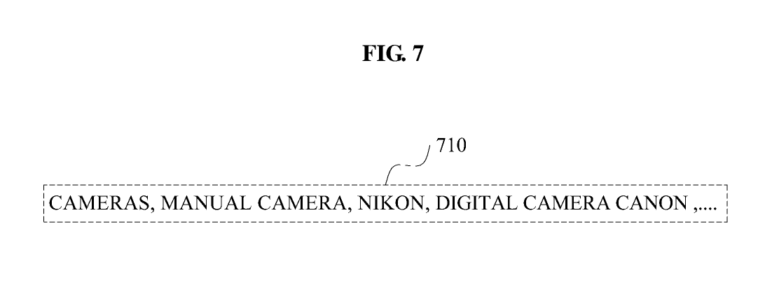

FIG. 7 is a diagram illustrating an example of a related keyword associated with a keyword analyzed based on a minimum unit.

Referring to FIG. 7, the impression keyword generation unit 230 may extract a related keyword 710 by analyzing the keywords included in the minimum unit list 400 illustrated in FIG. 4. The related keyword 710 is highly associated with the analyzed keywords. Also, the impression keyword generation unit 230 may generate an expanded impression keyword using the related keyword 710. For example, when a keyword ‘camera’ included in the minimum unit list 400 is entered as a query by users, and another query such as ‘cameras, manual camera, Nikon, digital camera, Canon’ is entered, a query pattern of the users may be analyzed in advance. Accordingly, the related keyword 710 such as ‘cameras, manual camera, Nikon, digital camera, Canon’ may be extracted as keywords highly associated with the keyword ‘camera’.

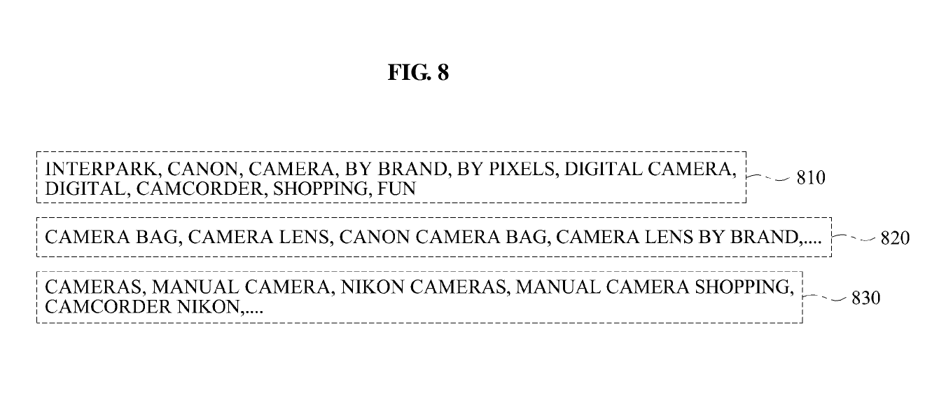

FIG. 8 is a diagram illustrating an example of an impression keyword generated using an autocomplete query, related keyword, or keyword analyzed based on a minimum unit.

Referring to FIG. 8, the impression keyword generation unit 230 may individually use the keyword, analyzed based on the predetermined unit, that is, the minimum unit, based on a result of the analyzing, and thereby may generate a first impression keyword 810. For example, keywords such as ‘Interpark, Canon, camera, by brand, by pixels, digital camera, digital, camcorder, fun, shopping’ included in the minimum unit list 400 illustrated in FIG. 4 may be individually used as is as the first impression keyword 810.

Also, the impression keyword generation unit 230 may combine the keywords analyzed based on the predetermined unit based on the result of the analyzing, and thereby may generate a second impression keyword 820 or third impression keyword 830. For example, the autocomplete query 610 illustrated in FIG. 6 may be individually used or used by combining, as the second impression keyword 820. Specifically, the second impression keyword 820, for example, ‘camera bag, camera lens, Canon camera bag, camera lens by brand’, may be generated by combining the autocomplete query 610 and the keywords, ‘Canon, camera, by brand’, included in the minimum unit list 400 illustrated in FIG. 4. Also, the related keyword 710 illustrated in FIG. 7 may be individually used or used by combining, as the third impression keyword 830. Specifically, the third impression keyword 830, for example, ‘cameras, manual camera, Nikon cameras, manual camera shopping, camcorder Nikon’, may be generated by combining the related keyword 710 and the keywords included in the minimum unit list 400 illustrated in FIG. 4.

As described above, the impression keyword generation unit 230 may combine the keyword analyzed based on the predetermined unit, and the autocomplete query or the related keyword to generate the impression keyword.

The comparison unit 240 compares the query and the impression keyword. Specifically, the comparison unit 240 compares the impression keyword and keyword included in the query entered by the user. For example, when the query is ‘camera’, the comparison unit 240 may compare the query, ‘camera’, and the impression keywords 510, 520, 530, 810, 820, and 830 illustrated in FIG. 5 and FIG. 8.

The advertisement presentation unit 250 presents an advertisement corresponding to the impression keyword based on a result of the comparing. Specifically, when the query is included in the impression keyword based on the result of the comparing, the advertisement presentation unit 250 may present the advertisement corresponding to the impression keyword. For example, since a query, ‘camera’ is included in the impression keywords 510, 520, 530, 810, 820, and 830 illustrated in FIG. 5 and FIG. 8, the advertisement presentation unit 250 may present an advertisement corresponding to the impression keywords. The advertisement presentation unit 250 may present a title, description, or URL of an advertiser website illustrated in FIG. 3, as the advertisement corresponding to the impression keywords as is. Also, the advertisement presentation unit 250 may present another type of advertisement which is previously registered by the advertiser.

The advertisement database 260 stores and maintains the title, description, or URL of the advertiser website, advertisement content, advertisement condition, and the like, entered by the advertiser. Also, the advertisement database 260 stores and maintains advertisement data corresponding to the impression keyword or advertisement keyword.

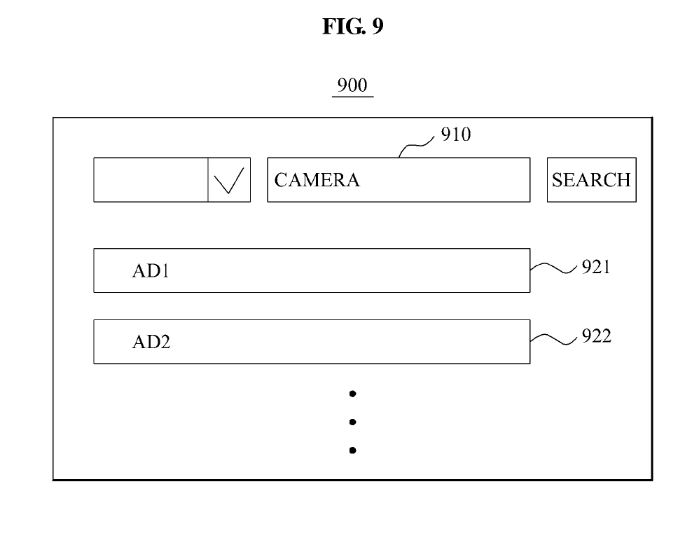

FIG. 9 is a diagram illustrating an example of presenting an advertisement corresponding to an input query.

Referring to FIG. 9, when a query 910, ‘camera’ is entered by a user on a search result screen 900, the advertisement presentation unit 250 may preferentially present an advertisement AD1 921 of an advertiser that purchases an advertisement keyword corresponding to the query based on the result of the comparing. Also, the advertisement presentation unit 250 may present an advertisement AD2 922 corresponding to an impression keyword of an advertiser that does not purchase the advertisement keyword. That is, when an advertisement keyword or impression keyword including the keyword, ‘camera’, which is the query 910 entered by the user, exists by referring to the advertisement database 260, the advertisement presentation unit 250 may preferentially present the advertisement AD1 921 corresponding to the advertisement keyword, and present the advertisement AD2 922 corresponding to the impression keyword of the advertiser that does not purchase the advertisement keyword.

As described above, the automatic search advertisement presentation system 120 may analyze the title or description of the advertiser website that does not separately purchase the advertisement keyword, and thereby may automatically present the advertisement.

Also, the automatic search advertisement presentation system 120 may analyze a keyword included in the title, description, content of the advertiser website, or advertisement condition, and use a variety of expanded keywords such as the autocomplete keyword, related keyword, recommended keyword, and the like. Accordingly, the automatic search advertisement presentation system 120 may present the advertisement of an advertiser that does not separately purchase the advertisement keyword.

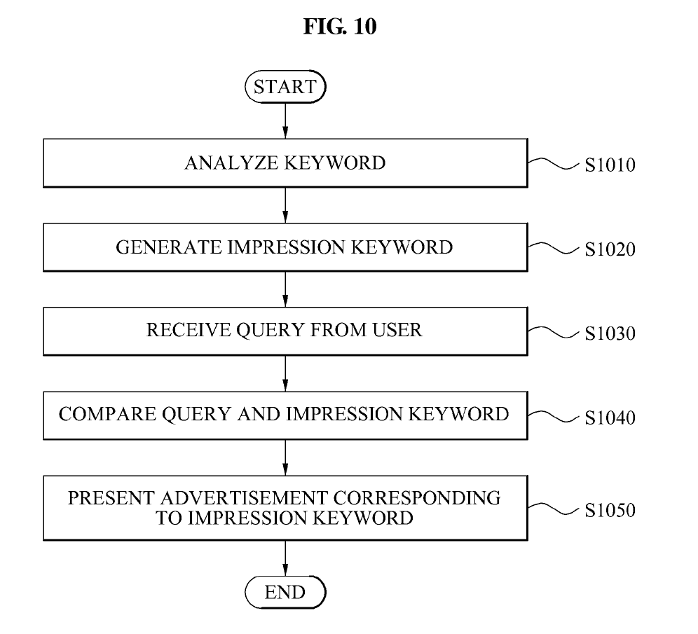

FIG. 10 is a flowchart illustrating an automatic search advertisement presentation method according to an embodiment of the present invention.

Referring to FIG. 10, in operation S1010, an automatic search advertisement presentation system 120 analyzes a keyword included in a title of an advertiser website, description of the advertiser website, content of the advertiser website, or condition entered by an advertiser. Specifically, in operation S1010, the automatic search advertisement presentation system 120 may analyze a keyword, included in advertisement content or the advertisement condition entered by the advertiser, through crawling using the title 310, description 320, and URL 330 of an advertiser website illustrated in FIG. 3. Also, in operation S1010, the automatic search advertisement presentation system 120 may analyze a keyword included in a title, description, content of an advertiser website, or advertisement condition of an advertiser that does not purchase an advertisement keyword.

Also, in operation S1010, the automatic search advertisement presentation system 120 may analyze the keyword, included in the title or description of the advertiser website, content of the advertiser website, or condition entered by the advertiser, based on a predetermined unit. For example, in operation S1010, the automatic search advertisement presentation system 120 may analyze keywords, ‘Interpark Canon camera’ included in the title 310 of the advertiser web site illustrated in FIG. 3, and separate the keywords into a minimum unit such as ‘Interpark, Canon, camera’ included in the minimum unit list 400 illustrated in FIG. 4.

Also, in operation S1010, the automatic search advertisement presentation system 120 may analyze the keywords ‘Canon camera, by brand, digital camera by pixels, digital camcorder, fun shopping at Interpark’ included in the description 320 of the advertiser website illustrated in FIG. 3, and separate the keywords into the minimum unit such as ‘Canon, camera, by brand, by pixels, digital camera, digital, camcorder, fun, shopping’ included in the minimum unit list 400 illustrated in FIG. 4.

Also, in operation S1010, the automatic search advertisement presentation system 120 may further include an operation of generating an autocomplete query or related keyword using the keyword analyzed based on the predetermined unit.

For example, in operation S1010, when a keyword ‘camera’ included in the minimum unit list 400 is entered by a user, and a query such as ‘camera bag’ or ‘camera lens’ is commonly entered, such a query of the user may be analyzed in advance. Accordingly, when the keyword ‘camera’ only is entered by the user, the automatic search advertisement presentation system 120 may automatically complete the autocomplete query 610 such as ‘camera bag, camera lens’ (FIG. 6).

For example, in operation S1010, when a keyword ‘camera’ included in the minimum unit list 400 is entered as a query by users, and another query such as ‘cameras, manual camera, Nikon, digital camera, Canon’ is entered, a query pattern of the users may be analyzed in advance. Accordingly, the automatic search advertisement presentation system 120 may generate a related keyword 710 such as ‘cameras, manual camera, Nikon, digital camera, Canon’ illustrated in FIG. 7. The related keyword 710 is highly associated with the keyword ‘camera’.

In operation S1020, the automatic search advertisement presentation system 120 generates an impression keyword based on a result of the analysis. Specifically, in operation S1020, the automatic search advertisement presentation system 120 may individually use the keyword, analyzed based on the predetermined unit, as the impression keyword, or combine the keywords analyzed based on the predetermined unit to generate the impression keyword.

For example, in operation S1020, the automatic search advertisement presentation system 120 may individually use the keyword, analyzed based on the predetermined unit, as the impression keyword based on the result of the analyzing. For example, keywords such as ‘Interpark, Canon, camera, by brand, by pixels, digital camera, digital, camcorder, fun, shopping’ included in the minimum unit list 400 illustrated in FIG. 4 may be individually used as is, as the impression keyword.

Also, in operation S1020, the automatic search advertisement presentation system 120 may individually use the keyword analyzed based on the predetermined unit, the autocomplete query, or the related keyword, or combine the keyword analyzed based on the predetermined unit, and the autocomplete query or the related keyword to generate the impression keyword.

For example, in operation S1020, the automatic search advertisement presentation system 120 may individually use the autocomplete query 610 illustrated in FIG. 6, or combine the autocomplete query 610 and keywords as the impression keyword. Specifically, the impression keyword may be generated, for example, ‘camera bag, camera lens, Canon camera bag, camera lens by brand’ by combining the autocomplete query 610 and the keywords, ‘Canon, camera, by brand’, included in the minimum unit list 400 illustrated in FIG. 4.

For example, in operation S1020, the automatic search advertisement presentation system 120 may individually use the related keyword 710 illustrated in FIG. 7, or combine the related keyword 710 and keywords as the impression keyword. Specifically, the impression keyword may be generated, for example, ‘cameras, manual camera, Nikon cameras, manual camera shopping, camcorder Nikon’, by combining the related keyword 710 and the keywords included in the minimum unit list 400 illustrated in FIG. 4.

In operation S1030, the automatic search advertisement presentation system 120 may receive a query from the user. Specifically, in operation S1030, the automatic search advertisement presentation system 120 may receive a query corresponding to content desired to be retrieved from the user. For example, in operation S1030, the automatic search advertisement presentation system 120 may receive a query such as ‘camera’ from the user.

In operation S1040, the automatic search advertisement presentation system 120 compares the query and the impression keyword. Specifically, the automatic search advertisement presentation system 120 compares the impression keyword and the keyword included in the query.

In operation S1050, the automatic search advertisement presentation system 120 presents an advertisement corresponding to the impression keyword based on a result of the comparing. Specifically, in operation S1050, when the keyword included in the query is included in the impression keyword as the result of the comparing, the automatic search advertisement presentation system may present the advertisement corresponding to the impression keyword.

Also, in operation S1050, the automatic search advertisement presentation system 120 may preferentially present an advertisement of an advertiser that purchases an advertisement keyword corresponding to the impression keyword included in the query based on the result of the comparing, and present an advertisement corresponding to an impression keyword of an advertiser that does not purchase the advertisement keyword.

For example, in operation S1050, when an advertisement keyword or impression keyword including the keyword, ‘camera’, which is the query 910 entered by the user, exists, the automatic search advertisement presentation system 120 may preferentially present the advertisement AD1 921 corresponding to the advertisement keyword, and present the advertisement AD2 922 corresponding to the impression keyword of the advertiser that does not purchase the advertisement keyword.

As described above, the automatic search advertisement presentation method 120 may analyze a keyword included in a title, description, or condition of advertiser website, generate a variety of expanded keywords such as an autocomplete keyword, related keyword, recommended keyword, and the like, and present an advertisement.

Also, the automatic search advertisement presentation method uses request information of an advertiser or input information of a user, and thereby may address a request from the user and advertiser to present an advertisement.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to an embodiment of the present invention, an automatic search advertisement presentation method and system, when an advertiser does not purchase an advertisement keyword, analyzes a title or description of a website of the advertiser and presents an advertisement.

Also, according to an embodiment of the present invention, an automatic search advertisement presentation method and system presents an advertisement when a keyword is inputted as a query based on a result of analyzing a title, content, description, or condition of an advertisement website.

Also, according to an embodiment of the present invention, an automatic search advertisement presentation method and system analyzes a keyword included in a title, content, description, or condition of an advertisement website, generates a variety of expanded keywords such as an autocomplete keyword, related keyword, recommended keyword, and the like, and presents an advertisement.

Also, according to an embodiment of the present invention, an automatic search advertisement presentation method and system addresses a request of an advertiser by using request information of the advertiser to present an advertisement.

Also, according to an embodiment of the present invention, an automatic search advertisement presentation method and system addresses a request of a user by using input information of the user to present an advertisement.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An automatic search advertisement presentation method, comprising:
analyzing a keyword included in a title of an advertiser website, description of the advertiser website, content of the advertiser website, or condition entered by an advertiser;
generating an impression keyword based on a result of the analysis;
receiving a query from a user;
comparing the query and the impression keyword; and
presenting an advertisement corresponding to the impression keyword based on a result of the comparing.

2. The automatic search advertisement presentation method of claim 1, wherein analyzing the keyword included in the title of the advertiser website, description of the advertiser website, content of the advertiser website, or condition entered by the advertiser, comprises analyzing the keyword based on a predetermined unit.

3. The automatic search advertisement presentation method of claim 2, wherein the generating comprises individually generating the keyword analyzed based on the predetermined unit as the impression keyword, or combines a plurality of the keywords analyzed based on the predetermined unit to generate the impression keyword.

4. The automatic search advertisement presentation method of claim 2, wherein the analyzing the keyword in the title of the advertiser website or the description of the advertiser website comprises:
generating an autocomplete query or related keyword using the keyword analyzed based on the predetermined unit.

5. The automatic search advertisement presentation method of claim 4, wherein the generating of the impression keyword individually uses the keyword analyzed based on the predetermined unit, the autocomplete query, or the related keyword, or combines the keyword analyzed based on the predetermined unit and the autocomplete query or the related keyword to generate the impression keyword.

6. The automatic search advertisement presentation method of claim 1, wherein the comparing compares a keyword included in the query and the impression keyword.

7. The automatic search advertisement presentation method of claim 1, wherein the presenting presents the advertisement corresponding to the impression keyword, when the query is included in the impression keyword based on the result of the comparing.

8. The automatic search advertisement presentation method of claim 1, wherein the presenting preferentially presents an advertisement of an advertiser that purchases an advertisement keyword corresponding to the impression keyword based on the result of the comparing.

9. A non-transitory computer-readable storage medium comprising an executable program, which when executed, performs the steps of:
detects a keyword included in a title of an advertiser website, description of the advertiser website, content of the advertiser website, or condition entered by an advertiser and analyzes the keyword:
generates an impression keyword based on a result of the analysis;
detects a query from a user and receives the query from the user;
compares the query and the impression keyword; and
detects an advertisement corresponding to the impression keyword in response to the comparison and presents the advertisement.

10. An automatic search advertisement presentation system, comprising:
an advertisement analysis unit operable to analyze a keyword included in a title of an advertiser website, description of the advertiser website, content of the advertiser website, or condition entered by an advertiser;
an impression keyword generation unit operable to generate an impression keyword in response to a result of the analysis;
an input unit operable to receive a query from a user;
a comparison unit operable to compare the query and the impression keyword; and
an advertisement presentation unit operable to present an advertisement corresponding to the impression keyword in response to a result of the comparing.

11. The automatic search advertisement presentation system of claim 10, wherein the advertisement analysis unit is operable to analyze the keyword, included in the title of the advertiser website, description of the advertiser website, content of the advertiser website, or condition entered by the advertiser, based on a predetermined unit.

12. The automatic search advertisement presentation system of claim 11, wherein the impression keyword generation unit is operable to individually generate the keyword analyzed based on the predetermined unit as the impression keyword, or combine the keywords analyzed based on the predetermined unit to generate the impression keyword.

13. The automatic search advertisement presentation system of claim 11, wherein the advertisement analysis unit is operable to analyze an autocomplete query or related keyword as an expanded keyword, the autocomplete query or related keyword being generated using the keyword analyzed based on the predetermined unit.

14. The automatic search advertisement presentation system of claim 13, wherein the impression keyword generation unit is operable to individually use the keyword analyzed based on the predetermined unit or the expanded keyword, or to combine the keywords analyzed based on the predetermined unit and the expanded keyword to generate the impression keyword.

15. The automatic search advertisement presentation system of claim 14, wherein the comparison unit is operable to compare a keyword included in the query and the impression keyword.

16. The automatic search advertisement presentation system of claim 15, wherein the advertisement presentation unit is operable to present the advertisement corresponding to the impression keyword, when the query is included in the impression keyword in response to the result of the comparing.

17. The automatic search advertisement presentation system of claim 10, wherein the advertisement presentation unit is operable to preferentially present an advertisement of an advertiser that purchases an advertisement keyword corresponding to the impression keyword based on the result of the comparing.
